(19) United States
(12) Patent Application Publication
(10) Pub. No.: US 2007/0024351 A1
(43) Pub. Date: Feb. 1, 2007

(54) Circuit for generating internal power voltage

(75) Inventor: Yong-Gu Kang, Ichon-shi (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/321,875

(22) Filed: Dec. 30, 2005

(30) Foreign Application Priority Data
Aug. 1, 2005 (KR) 2005-0070375

(51) Int. Cl. G05F 1/10

(52) U.S. Cl. 327/541

(57) ABSTRACT

There is provided a circuit for generating an internal power voltage capable of stably controlling an internal power voltage before generating a reference voltage during an initial power-up operation of a semiconductor device. The circuit for generating an internal power voltage includes: an internal power reset controller for outputting a control signal in response to an activated reference signal and an external power voltage wherein the reference signal is activated after the external power voltage is inputted; and an internal power generator for generating the internal power voltage using the external power voltage in response to the activated reference signal wherein the internal power generator is disabled in response to the control signal.

### FIELD OF THE INVENTION

The present invention relates to a design technology for a semiconductor device; and more particularly, to a circuit for generating an internal power voltage, capable of stably controlling an internal power voltage before generating a reference voltage during an initial power-up operational mode of a semiconductor memory device.

### DESCRIPTION OF RELATED ART

FIG. 1 is a block diagram setting forth a conventional circuit for generating an internal power voltage.

Referring to FIG. 1, the conventional circuit for generating the internal power voltage includes a reference voltage generator 10, an internal power generator 20 and an internal circuit 30.

Herein, the reference voltage generator 10 receives an external power voltage VEXT so as to generate a reference voltage VREF. The internal power generator 20 applies an internal power voltage VINT as a power for the internal circuit 30 according to the external power voltage VEXT and the reference voltage VREF.

FIG. 2 is a circuit diagram illustrating the internal power generator 20 of FIG. 1.

Referring to FIG. 2, the internal power generator 20 is provided with a differential amplifier 21, a power driver 22 and a resistance divider 23.

Herein, the differential amplifier 21 compares the reference voltage VREF with a divided voltage VD according to an operational activate signal EN1 and controls a voltage level of a driving signal SWB according to the comparison result.

The power driver 22 has a first PMOS transistor P1 connected between a terminal of the external power voltage VEXT and an output terminal of the internal power voltage VINT, wherein the driving signal SWB is applied to a gate of the first PMOS transistor P1. The resistance divider 23 has a first resistor R1 and a second resistor R2 connected to each other in series between the output terminal of the internal power voltage VINT and a ground voltage terminal, which outputs the divided voltage VD of the internal power voltage VINT.

FIG. 3 is a circuit diagram depicting the differential amplifier 21 of FIG. 2.

Referring to FIG. 3, the differential amplifier is configured with a second PMOS transistor P2 and a third PMOS transistor P3, and a first to third NMOS transistors N1, N2 and N3.

Herein, the external power voltage VEXT is applied through a common source terminal of the second and the third PMOS transistors P2 and P3 of which gates are commonly connected to each other. The first and the second NMOS transistors N1 and N2 are connected between the second and the third transistors P2 and P3 and the third NMOS transistor N3, wherein the reference voltage VREF and the divided voltage VD are applied to each gate of the first and the second NMOS transistors N1 and N2, respectively. The third transistor N3 is connected between the first and the second NMOS transistors N1 and the N2 and the ground voltage, wherein the operational activate signal EN1 is applied to a gate thereof.

An illustration for an operational procedure of the conventional circuit for generating the internal power voltage will be set forth hereinafter with reference to a timing diagram described in FIG. 4.

To begin with, when the external power voltage VEXT is applied, the reference voltage generator 10 generates the reference voltage VREF. In case that the differential amplifier 21 is enabled by the operational activate signal EN1, the reference voltage VREF and the divided voltage VD, i.e., a voltage that the internal power voltage VINT is divided by the resistors R1 and R2, are applied to the differential amplifier 21, respectively.

Thereafter, the differential amplifier compares the divided voltage VD with the reference voltage VREF so as to control the driving signal SWB according to the level of the internal power voltage VINT. The first PMOS transistor P1 maintains the internal power voltage VINT to have a predetermined voltage level according to the driving signal SWB. Herein, the internal power voltage VINT keeps a predetermined value expressed as a following equation, i.e., VINT=((R1+R2)/R2)*VREF.

If the level of the internal power voltage VINT becomes lower than the predetermined value expressed as the above, i.e., VINT=((R1+R2)/R2)*VREF, a gate-source voltage Vgs of the first NMOS transistor N1 becomes higher than a gate-source voltage Vgs of the second NMOS transistor N2. Accordingly, the voltage level of the driving signal SWB becomes lowered and a drivability of the first PMOS transistor becomes increased, to thereby increase the level of the internal voltage level VINT.

On the contrary, provided that the level of the internal power voltage VINT becomes higher than the predetermined value, i.e., VINT=((R1+R2)/R2)*VREF, the gate-source voltage Vgs of the first NMOS transistor N1 becomes lower than the gate-source voltage Vgs of the second NMOS transistor N2. Accordingly, the voltage level of the driving signal SWB rises up and a drivability of the first PMOS transistor P1 becomes lowered, to thereby decrease the level of the internal voltage level VINT.

Therefore, the voltage level of the internal power voltage VINT is increased or decreased according to the control of the driving signal SWB so that it is possible to stably apply the internal power voltage VINT of which the voltage level is preset to the internal circuit 30.

However, if the external power voltage VEXT is applied during an initial power-up operational mode in the conventional circuit for generating the internal power voltage, the voltage level of the internal power voltage VINT rises up higher than a target level B before generating the reference voltage VREF because the internal power voltage VINT is affected by the external power voltage VEXT. Thus, there is a problem in the conventional circuit to incur a misoperation of the internal circuit 30.

### SUMMARY OF THE INVENTION

It is, therefore, an object of the present invention to provide a circuit for generating an internal power voltage capable of stably controlling an internal power voltage before generating a reference voltage during an initial power-up operational mode of a semiconductor memory device and preventing a misoperation of an internal circuit.

In accordance with an aspect of the present invention, there is provided a circuit for generating an internal power voltage, including: an internal power reset controller for outputting a control signal in response to an activated reference signal and an external power voltage wherein the reference signal is activated after the external power voltage is inputted; and an internal power generator for generating the internal power voltage using the external power voltage in response to the activated reference signal wherein the internal power generator is disabled in response to the control signal.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram setting forth a conventional circuit for generating an internal power voltage;

FIG. 2 is a circuit diagram illustrating the internal power generator of FIG. 1;

FIG. 3 is a circuit diagram representing the differential amplifier of FIG. 2;

FIG. 4 is a timing diagram explaining an operation of the conventional circuit for generating the internal power voltage;

FIG. 5 is a block diagram setting forth a circuit for generating an internal power voltage in accordance with the present invention;

FIG. 6 is a circuit diagram illustrating the internal power generator and the internal power reset controller of FIG. 5;

FIG. 7 is a circuit diagram representing the internal power generator of FIG. 6; and

FIG. 8 is a timing diagram explaining an operation of the circuit for generating the internal power voltage in accordance with the present invention.

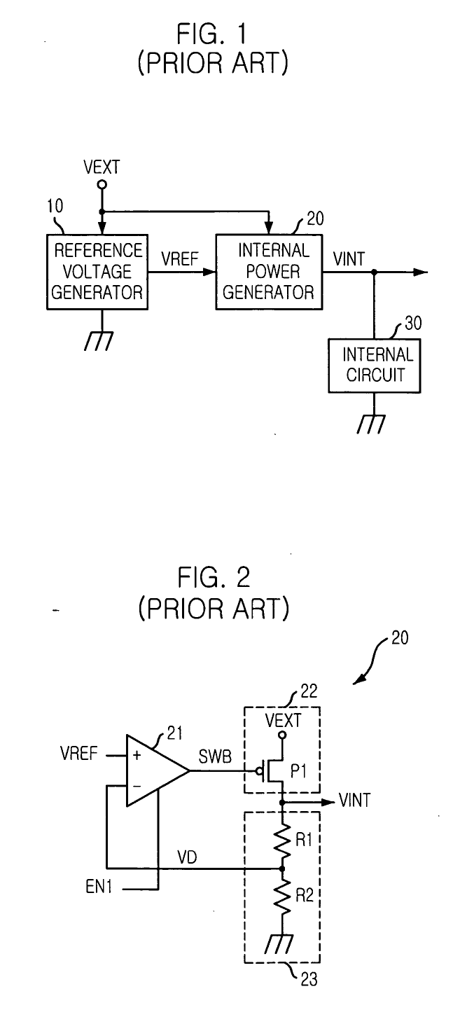

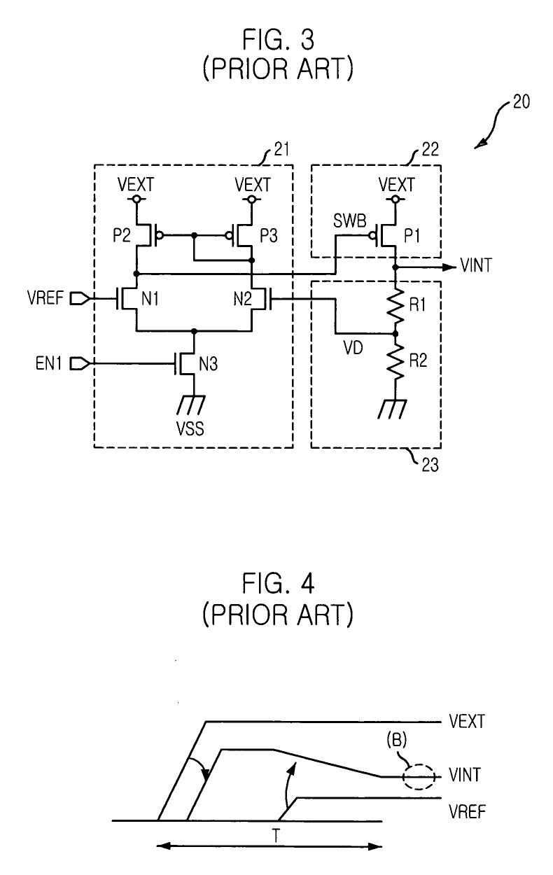

### DETAILED DESCRIPTION OF THE INVENTION

Other objects and aspects of the invention will become apparent from the following description of the embodiments with reference to the accompanying drawings, which is set forth hereinafter.

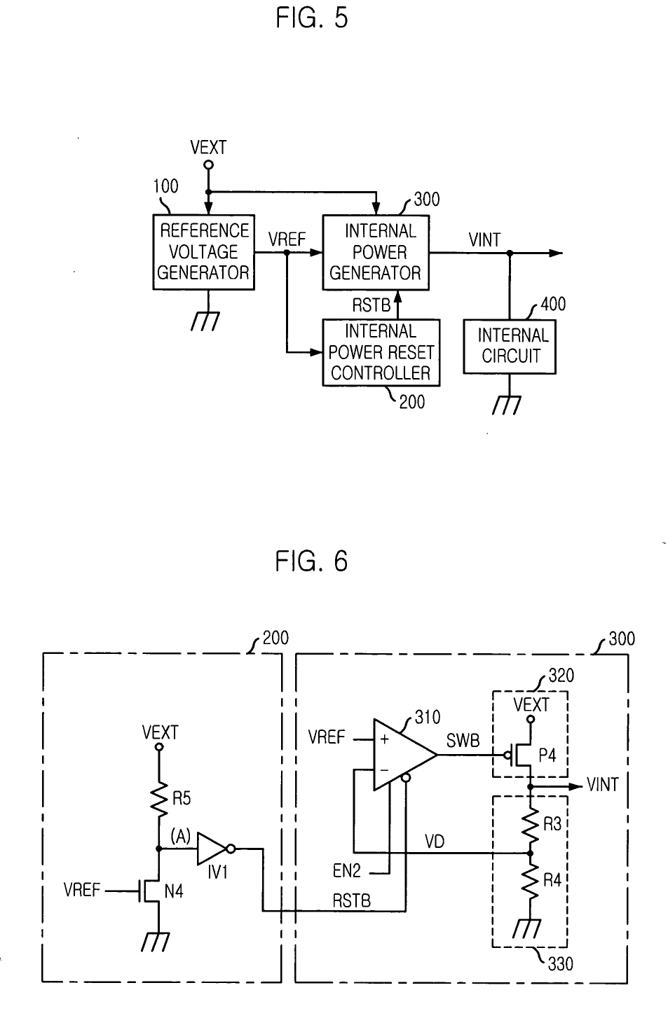

FIG. 5 is a block diagram setting forth a circuit for generating an internal power voltage in accordance with the present invention.

Referring to FIG. 5, the circuit for generating an internal power voltage includes a reference voltage generator 100, an internal power reset controller 200, an internal power generator 300 and an internal circuit 400.

Herein, the reference voltage generator 100 receives an external power voltage VEXT so as to generate a reference voltage VREF. The internal power reset generator 200 generates a control signal RSTB according to the reference voltage VREF and resets the internal power generator 300. Accordingly, it is possible to prevent an internal power voltage VINT from rising up according to the external power voltage VEXT till the reference voltage VREF reaches to a stabilized level after being generated during an initial power-up operational mode. The internal power generator 300 applies the internal power voltage VINT as a power for the internal circuit 400 according to the external power voltage VEXT, the reference voltage VREF and the control signal RSTB.

FIG. 6 is a circuit diagram illustrating the internal power reset controller 200 and the internal power generator 300 of FIG. 5.

At first, the internal power reset controller 200 is provided with a resistor R5, an NMOS transistor N4 and an inverter IV1. Herein, the resistor R5 is connected between the external power voltage VEXT and a node A. The NMOS transistor N4 connected between the node A and a ground voltage, wherein the reference voltage VREF is applied to a gate thereof. The inverter IV1 inverts the output signal of the node A.

The internal power generator 300 is provided with a differential amplifier 310, a power driver 320 and a resistance divider 330.

Herein, the differential amplifier 310 compares the reference voltage VREF with a divided voltage VD according to a controlling state of an operational activate signal EN2 and a rest signal RSTB, and then controls a voltage level of a driving signal SWB according to-the comparison result.

The power driver 320 has a PMOS transistor P4 connected between a terminal of the external power voltage VEXT and an output terminal of the internal power voltage VINT, wherein the driving signal SWB is applied to a gate of the PMOS transistor P4. The resistance divider 330 has a first and a second resistors R3 and R4 connected to each other in series between the output terminal of the internal power voltage VINT and a ground voltage, which outputs the divided voltage VD of the internal power voltage VINT.

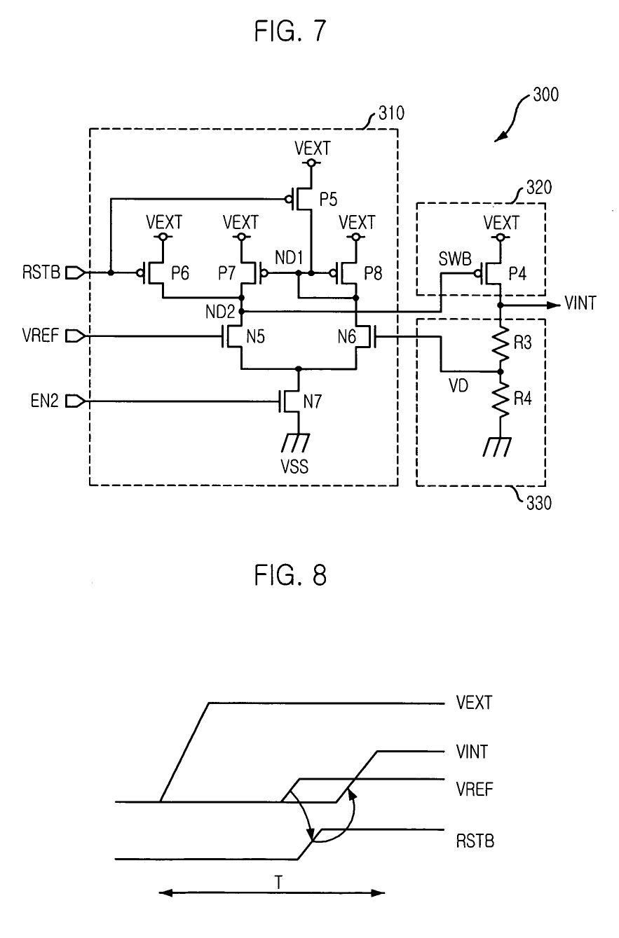

FIG. 7 is a circuit diagram representing the internal power generator 300 of FIG. 6. In particular, FIG. 7 depicts the differential amplifier 310 in detail.

Referring to FIG. 7, the differential amplifier 310 is configured with a plurality of PMOS transistors P5 to P8, and a plurality of NMOS transistors N5 to N7.

Herein, the PMOS transistor P5 is connected between an applied terminal of the external power voltage VEXT and a node ND1, wherein the control signal RSTB is applied through a gate terminal thereof. The PMOS transistor P6 is connected between the external power voltage VEXT and an output node ND2, wherein the control signal RSTB is applied through a gate terminal thereof.

In addition, the external power voltage VEXT is applied through a common source terminal of the PMOS transistors P7 and P8 and the gates are commonly connected to the node ND1. The NMOS transistors N5 and N6 are connected between the PMOS transistors P7 and P8 and the NMOS transistor N7, wherein the reference voltage VREF and the divided voltage VD are applied to the gates of the NMOS transistors N5 and N6, respectively. The NMOS transistor N7 is connected between the ground voltage and the NMOS transistors N5 and N6, wherein the operational activate signal EN2 is applied through the gate thereof.

An illustration for an operational procedure of the inventive circuit for generating the internal power voltage will be set forth hereinafter with reference to a timing diagram described in FIG. 8.

To begin with, when the external power voltage VEXT is applied, the reference voltage generator 100 generates the reference voltage VREF. In case that the differential amplifier 310 is enabled by the operational activate signal EN2, the reference voltage VREF and the divided voltage VD, i.e., a voltage that the internal power voltage VINT is divided by the resistors R3 and R4, are applied to the differential amplifier 310, respectively.

Thereafter, the differential amplifier 310 compares the reference voltage VREF with the divided voltage VD so as to control the driving signal SWB according to the level of the internal power voltage VINT. The PMOS transistor P4 maintains the internal power voltage VINT to have a predetermined voltage level according to the driving signal SWB. Herein, the internal power voltage keeps a predetermined value expressed as a following equation, i.e., VINT=((R3+R4)/R4)*VREF.

If the level of the internal power voltage VINT becomes lower than the predetermined value expressed as the above, i.e., VINT=((R3+R4)/R4)*VREF, a gate-source voltage Vgs of the NMOS transistor N5 becomes higher than a gate-source voltage Vgs of the NMOS transistor N6. Accordingly, the voltage level of the driving signal SWB becomes lowered and a drivability of the first PMOS transistor becomes increased, to thereby increase the level of the internal voltage level VINT.

On the contrary, provided that the level of the internal power voltage VINT becomes higher than the predetermined value, i.e., VINT=((R3+R4)/R4)*VREF, the gate-source voltage Vgs of the NMOS transistor N5 becomes lower than the gate-source voltage Vgs of the NMOS transistor N6. Accordingly, the voltage level of the driving signal SWB rises up and a drivability of the PMOS transistor P4 becomes lowered, to thereby decrease the level of the internal voltage level VINT.

Therefore, the voltage level of the internal power voltage VINT is increased or decreased according to the control of the driving signal SWB so that it is possible to stably apply the internal power voltage VINT of which the voltage level is preset, to the internal circuit 400.

However, unless the circuit for generating the internal power voltage is initialized during an initial power-up operational mode, the internal power voltage VINT rises up according to the external power voltage VEXT. Thus, in order to overcome the above problem, the control signal RSTB becomes activated to be in logic low level before generating the reference voltage VREF in the present invention.

That is, the internal power reset controller 200 outputs the external power voltage VEXT as the output signal of logic high level at the node A by means of the resistor R5 during the initial power-up operational mode. The inverter IV1 inverts the output signal of logic high level of the node A so as to output the control signal RSTB of logic low level. At this time, since the reference voltage VREF is not generated in the reference voltage generator 100 yet, the reference voltage VREF is still in logic low level.

Afterwards, in case that the control signal RSTB becomes in logic low level, the PMOS transistor P4 of the differential amplifier 310 becomes turned on. As a result, the driving signal SWB becomes in logic high level so that the PMOS transistor P4 maintains to be turned off. Therefore, the internal power voltage VINT is not generated during the initial power-up operational mode so that it is possible to address the problem the internal power voltage VINT rises up abnormally.

Thereafter, in case that the reference voltage VREF is generated in the reference voltage generator 100, the NMOS transistor N4 is turned on so that the output of the node A becomes in logic low level. The inverter IV1 inverts the output signal of logic low level of the node A so that the control signal RSTB becomes in logic high level. If the control signal RSTB becomes in logic high level, the PMOS transistor P6 is turned off so that the internal power voltage VINT is generated normally.

As described above, in accordance with the present invention, the inventive circuit for generating an internal power voltage is effective for stably controlling an internal power voltage before generating a reference voltage during an initial power-up operational mode of a semiconductor memory device. As a result, it is possible to prevent a misoperation of the internal circuit.

The present application contains subject matter related to Korean patent application No. 2005-70375, filed in the Korean Intellectual Property Office on Aug. 1, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A circuit for generating an internal power voltage, comprising:
an internal power reset controller for outputting a control signal in response to an activated reference signal and an external power voltage wherein the reference signal is activated after the external power voltage is inputted; and
an internal power generator for generating the internal power voltage using the external power voltage in response to the activated reference signal wherein the internal power generator is disabled in response to the control signal.

2. The circuit as recited in claim 1, wherein the internal power reset controller has a predetermined delay time till the control signal becomes inactivated after the reference signal is generated.

3. The circuit as recited in claim 1, wherein the internal power reset controller activates the reset signal to be in logic low level by inverting the level of the external power voltage through a resistor in case that the reference voltage is in logic low level, and inactivates the reset signal to be in logic high level by inverting the level of a ground voltage in case that the reference voltage is in logic high level.

4. The circuit as recited in claim 1, wherein the internal power reset controller includes:
a resistor connected between the external power voltage and a first node;
a first driving element connected between the first node and the ground voltage, of which operation is controlled according to a level of the reference voltage; and
an inverter for inverting the output of the first node to output the reset signal.

5. The circuit as recited in claim 1, wherein the internal power generator includes:
a differential amplifier for comparing the reference voltage with the divided voltage according to the reset signal and an operational activate signal so as to output the driving signal;
a power driver connected between the external power voltage and an output terminal of the internal power voltage, which is selectively operated according to a voltage level of the driving voltage; and
a resistance divider connected between the power driver and the ground voltage, for outputting the divided voltage.

6. The circuit as recited in claim 5, wherein the differential amplifier includes:
a second driving element connected between the external power voltage and a second node, the reset signal being applied to a gate thereof;
a third driving element connected between the external power voltage and a third node, the reset signal being applied to a gate thereof;
a fourth and a fifth driving elements of which gates are commonly connected to the third node, for selectively applying the external power voltage;
a sixth element for selectively applying the ground voltage according to the operational activate signal; and
a seventh and an eighth driving elements connected between the fourth and the fifth driving elements and the sixth driving element respectively, the reference voltage and the divided voltage being applied to gates thereof, respectively.

7. The circuit as recited in claim 6, wherein the second driving element includes a first PMOS transistor.

8. The circuit as recited in claim 6, wherein the third driving element includes a second PMOS transistor.
